(19) United States
(12) Patent Application Publication
(10) Pub. No.: US 2009/0024487 A1
(43) Pub. Date: Jan. 22, 2009

(54) METHOD AND SYSTEM FOR OFFERING AND COMMERCIALIZING PROPOSALS

(76) Inventor: Mehran Mehregany, Pepper Pike, OH (US)

Correspondence Address: SQUIRE SANDERS & DEMPSEY LLP, TWO RENAISSANCE SQUARE, 40 NORTH CENTRAL AVENUE, SUITE 2700, PHOENIX, AZ, 85004-4498, US

(21) Appl. No.: 12/039,631

(22) Filed: Feb. 28, 2008

Related U.S. Application Data
(63) Continuation of application No. 10/446,900, filed on May 27, 2003, now abandoned.

(51) Int. Cl. G06Q 30/00

(52) U.S. Cl. 705/26

(57) ABSTRACT

A method for facilitating the development of research proposals is provided. Each user is registered as a supplier or as a buyer. Then, for each of the suppliers, one or more proposal abstracts are accepted. Each proposal abstract is stored in a database. A search request for proposal abstracts meeting a criteria is received from at least one of the buyers. A list of matching proposal abstracts that meet the criteria of the search request is sent to the one of the buyer. A request to view one or more of the proposal abstracts from the list of matching proposal abstracts is received from one of the buyers. Each of the one or more proposal abstracts is sent to the buyer.

### CROSS-REFERENCE TO RELATED APPLICATION

This application is a continuation of and claims priority to U.S. patent application Ser. No. 10/446,900, filed May 27, 2003, the disclosure of which is incorporated herein by reference in its entirety for all purposes.

### TECHNICAL FIELD OF THE INVENTION

This invention relates to the field of intellectual property development and, more particularly, to a method and system for offering and commercializing proposals.

### BACKGROUND OF THE INVENTION

Organizations that develop technology and solutions are known as suppliers of research and development services. These suppliers can be university, government labs, private companies and the like. These organizations often face the problem of finding compatible partners that are able to fund, develop and commercialize the suppliers technology.

On the other side, there are organizations whose business it is to turn new technology into a money making endeavor. These are known as buyers of research and development. They face the similar problem of matching their area of expertise with opportunities to develop and commercialize new technologies.

Therefore, what is needed is a method and system for offering, developing and commercializing proposals.

### SUMMARY OF THE INVENTION

In one embodiment a method for facilitating the development of research proposals is provided. Each user is registered as a supplier or as a buyer. Then, for each of the suppliers, one or more proposal abstracts are accepted. Each proposal abstract is stored in a database. A search request for proposal abstracts meeting a criteria is received from at least one of the buyers. A list of matching proposal abstracts that meet the criteria of the search request is sent to the one of the buyer. A request to view one or more of the proposal abstracts from the list of matching proposal abstracts is received from the one of the buyer. Each of the one or more proposal abstracts is sent to the buyer.

The present invention provides a resource for marketing proposed discovery, development, and commercialization efforts and capabilities. Non-confidential “Proposal Abstracts” are posted on a network by suppliers of such research and development (R&D) services, including universities, research organizations, government labs, and companies (in particular small businesses). Each Proposal Abstract represents a fundable proposal, i.e. a bid. Proposal Abstracts are of a standard format, including descriptions of innovative claims and significance, timetable and deliverables, budget, proposal team and related experience, intellectual property rights, and contact information.

Potential buyers (e.g., companies, consortia, government, etc.) of such services can easily search the proposal abstract databases based on a number of criteria (e.g., proposal type, topical area, posting date, budget size, etc.) to identify one or more Proposal Abstracts that meet a prospective buyer's R&D interests. Once buyers have identified specific proposals of interest, they then use the contact information on the Proposal Abstract to directly contact the proposing organization for further inquiry or for accepting the proposal bid (the buyer's acceptance of a proposal bid is termed “a successful match”).

### BRIEF DESCRIPTION OF THE DRAWINGS

Non-limiting and non-exhaustive preferred embodiments of the present invention are described with references to the following figures wherein like reference numerals refer to like parts throughout the various views unless otherwise specified.

FIG. 1 is a block diagram of an exemplary system for offering, developing and commercializing proposals;

FIG. 2 is a block diagram of the parts of the proposal network web site;

FIG. 3 is a block diagram of the functions of the supplier user and gatekeeper;

FIG. 4 is an exemplary proposal abstract form,

FIG. 5 is an exemplary proposal abstract;

FIG. 6 is a block diagram of the functions of the buyer user and gatekeeper;

FIG. 7 is an exemplary search page;

FIG. 8 is a exemplary search result page; and

FIG. 9 is a flowchart of the operation of the server.

### DETAILED DESCRIPTION OF THE PREFERRED EMBODIMENT

The method of the present invention includes three groups—buyers of technology, suppliers of technology and the facilitator or host that provides the infrastructure for the submission and retrieval of proposal abstracts. Suppliers who develop a new technology or solution draft proposal abstracts that outline the technology and uploads them to a searchable network. Buyers search the database of proposal abstracts for proposals that mesh with the interest of the buyers organization. The buyers and the suppliers can then get together and make deals between the suppliers and buyers. In the present invention, organizers are registered as either a supplier or a buyer. An organization cannot choose both. For the most part, proposal abstracts are posted by suppliers. Proposal abstracts are non-confidential descriptions of a proposal. Proposal abstracts are prepared by a Principle Investigator (person leading the proposed offering) and electronically submitted to by the suppliers' Gatekeepers. They may be listed under multiple topical areas (see topical areas headings in the next section on “Database of Proposal Abstracts”) and are assigned a Proposal Abstract Number for ease of tracking. Abstracts can be either restricted or non-restricted. Restricted proposal abstracts are available for searching by buyers only, anyone can search for non-restricted abstracts.

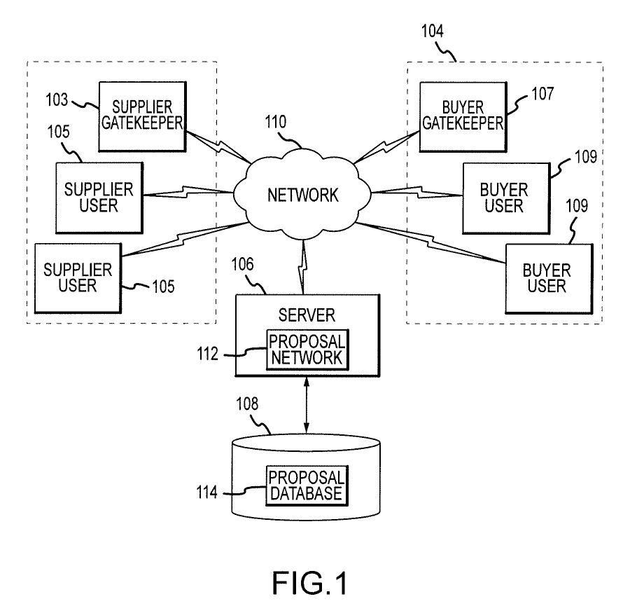

In one embodiment, the present invention is implemented using a system 100 as seen in FIG. 1. FIG. 1 is a block diagram of an exemplary system 100 for offering, developing and commercializing proposals. The system 100 includes a plurality of supplier computers 102 and buyer computers 104 coupled to a server computer 106 by a network 110. Server computer 106 couples to a storage system 108.

Supplier computers 102 and buyer computers 104 are any computing device capable of connecting to a networked environment to perform such tasks as to access information stored on other computers on the network or to communicate with other computers connected to the network client computer may be a personal computer, a hand held computer or personal digital assistant and the like. Supplier and buyer computer 102 and 104, in one embodiment are personal computers having a processor, a printer, an input device such as a keyboard and/or mouse, a monitor, a floppy disk drive, memory, a modem and/or computer network interface, and a mass storage device such as a hard disk drive and/or a readable/rewritable CD-ROM drive. Supplier and buyer computer 102 and 104 operate under the control of an operating system such as MS-DOS, WINDOWS 95/98/2000/NT/ME/XP, OS/2, UNIX, LINUX, MAC OS and the like. Supplier and buyer computer 102 and 104 run application programs including a web browser for accessing a web based program and web pages.

Supplier computer 102 further includes supplier gate keeper 103 and supplier user 105. Both gatekeeper and buyer are members of the supplier organization. Gate keepers are designated by the organization to be the individual that has administrative and management privileges and will be responsible for supporting proposal abstracts. Similarly, buyer computer 104 further includes those operated by buyer gatekeeper 107 and buyer user 109.

Web browsers are programs operable to access information on a network like the Internet. Web browsers communicate with server 104 using a protocol such as hyper text transfer protocol (HTTP). Web based program 110 is operable to receive information from server 106 or other supplier and buyer computers 102 and 104. A web browser can find a computer on the network to communicate with based on the network address of the computer and/or the uniform resource locator (URL) of a web page hosted on the computer. Information from a remote computer is then retrieved for use by supplier and buyer computer 102 and 104. In the present invention, the user of supplier and buyer computer 102 and 104 will utilize the browser 110 on supplier and buyer computer 102 and 104 to access web pages hosted by server 106.

Server 106 is any computer device capable of operating in a networked environment and receiving data and files in response to request from supplier and buyer computers 102 and 104. Server 106, such as the AS/400 or I series by International Business Machines of New York, will typically including a memory, a processor, a network connection and the like. Server 106 operates under the control of an operating system such as OS/400 by International Business Machines of New York. Server 106 is operable to run application programs such as web hosting programs. In the present invention a web based proposal network 112 web site is hosted by server 106 and accessed by supplier and buyer computer 102 and 104 using a web browser 110. The users of computers 102 and 104 will access the URL of the home page of the proposal net web site and from the web page navigate through web pages that provide the functionality of the proposal net application. The server 106 is operated by a third party to the supplier organization and the buyer organization. The operator of server 106 is responsible for providing secure access to the proposal net web site, providing access to the proposal abstract database and maintaining the web site.

Storage system 108 is any device capable of storing computer files including hard drives, tape drives and optical drives. In the present invention data such as the proposal access database 114 is stored in storage system 108 and accessible via server 106 using standard database access techniques.

Network 110 is any computer network, public or private. In one embodiment, network 110 is the Internet. However, network 110 can be any intranet, extranet, wide area network, and the like, public or private. While the system has been shown with a central server architecture, other architecture can be used, such as peer to peer networking where client computer, access each other without using a central server, without departing from the scope of the present invention.

In operation, a user of supplier computer 102 would post proposal abstracts to the proposal web site. Users of buyer computer 104 would be able to search the proposal networks proposal abstract database to find proposals of interest.

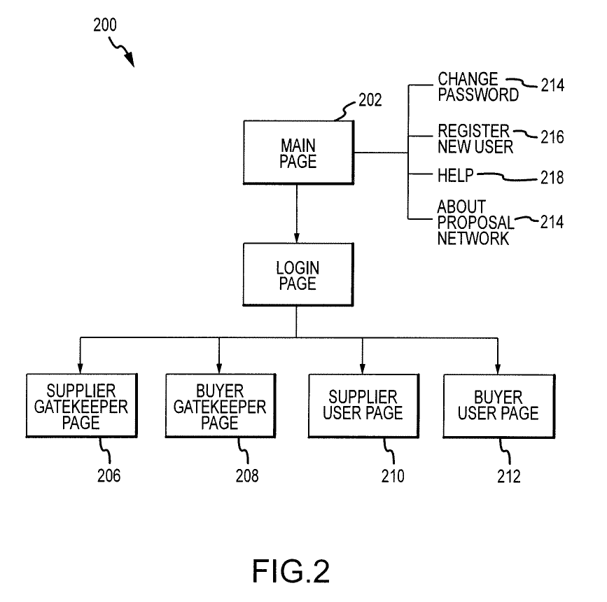

The proposal network web site housed on server 106 includes a main page 202 as illustrated in the block diagram of FIG. 2. Main page 202 is also known as the home page of the web hosted application and, as discussed previously, is accessed by the user entering the address of the web site or URL of the home page is entered into the web browser of the user. Once the user is at the main page 202, the user can, among other activities, change the user's password by selecting password change option 214, register as a new user by selecting new user option 216, get help on the proposal network system by selecting the set help option 218 and receive information on the system by selecting the information option 220.

The user can also log on to the system by selecting the log on option 204. Once logged on, the user will be then sent to a particular web page depending on what type of user has just logged on. In one embodiment, there are a supplier gatekeeper web page 206, a buyer gatekeeper web page 208, a supplier user web page 210 and a buyer user web page 212. As discussed previously, gatekeepers are certain members of either a supplier or buyer organization that are chosen to be responsible for management of the organization's proposals and other users.

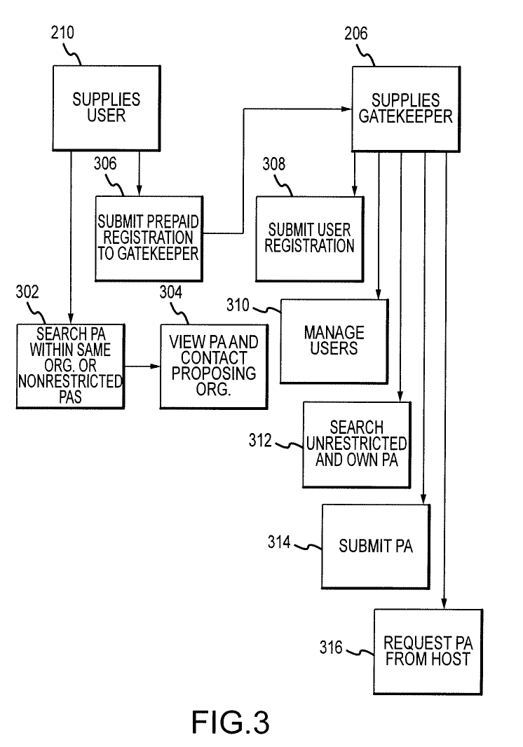

Supplier user web page 210, as illustrated in FIG. 3, allows the supplier user the ability to perform certain tasks. In one embodiment these tasks include searching non-restricted proposal abstracts or proposal abstracts within their own organization. As discussed previously, the main division between the supplier organization and the buyer organization is that the buyer typically searched for the proposal abstracts submitted by the supplier organization. However, suppliers can designate a proposal abstract to be “non-restricted” in order to get responses from other suppliers. Supplier users can also contact the proposing organization 304 for Proposal abstracts that were searched for and potential buyers to acquire the proposal.

Supplier users can also submit registration 308 and other information to supplier gatekeeper web page 206.

Supplier gatekeeper web page 206 lists options available to the gatekeeper. These include management options such as submitting new users 310 and managing users 310 in the organization. Additionally, the supplier gatekeeper has the option to search for non-restricted Proposal abstracts or Proposal abstracts from within an organization 312. The supplier gatekeeper additionally has the ability to submit proposal abstracts 314 for the organization. Also the supplier may request a proposal from the host. This is done in case where the supplier needs technology that could be found in a proposal. Since a user can be any supplier or a buyer, as a supplier it could not search all Proposal abstracts. By requesting the proposal from the host, the host can check to see of the supplier is requesting the proposal for an illegitimate reason.

As discussed previously, the proposal abstracts are generated by the individual submitting the proposal abstract, are in a standardized form and are non-confidential, i.e., do not contain proprietary information so it may be viewed by all potential buyers without the need for non-disclosure agreements. Proposal abstracts are submitted to the proposal database for ease of searching by buyers. Proposal abstracts have a limited lifetime. In one embodiment they are removed from the database after 120 days. This keeps the database from gathering old or out of date proposals.

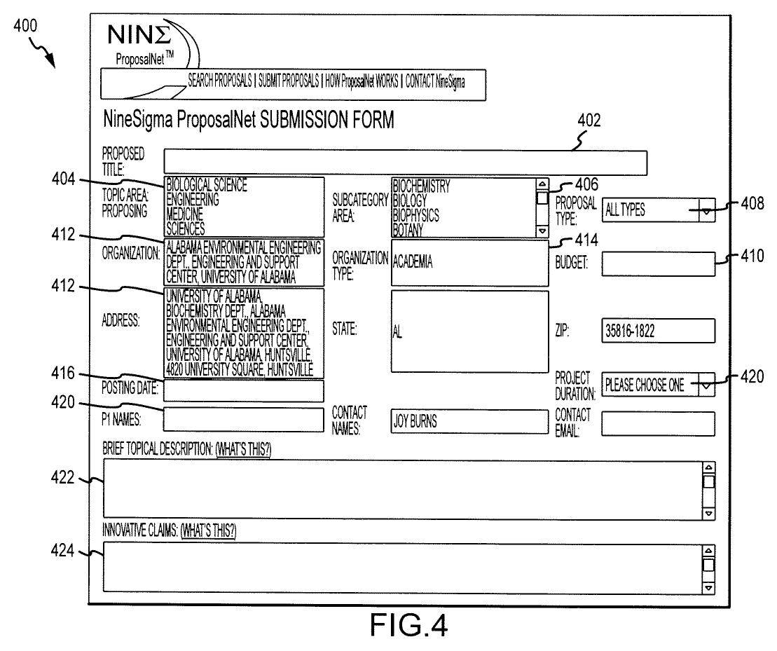

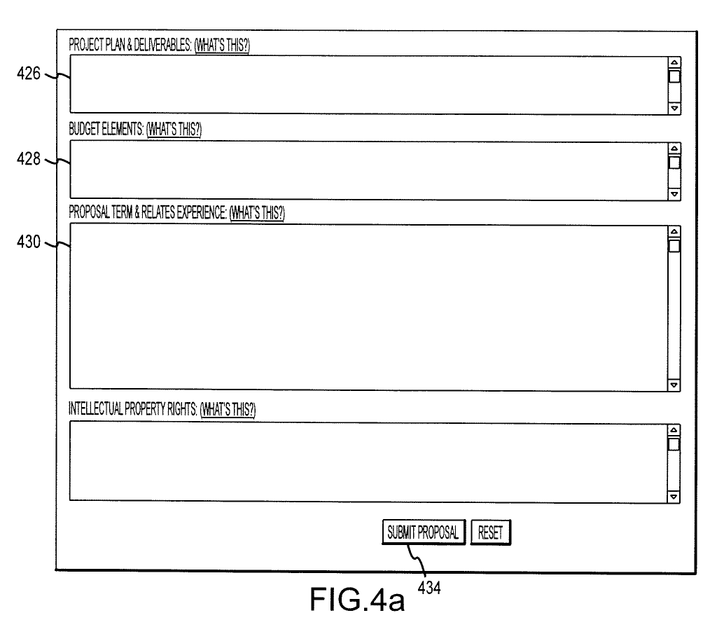

An exemplary electronic template 400 for a proposal abstract is shown in FIG. 4. The proposed title is entered in title box 402. Topical area is selected in topical area section 404. The topical area is typically selected by academic discipline or scientific area. The topical area can be further limited by choosing a sub-category of the topic area at sub-topical area section 406. The specific type of proposal can be selected using type selection box 408 which in one embodiment, is a pull down menu. The types of proposals can include basic research and applied research, development, prototyping, commercialization facilitation/equipment or a catch-all any type. The name and address of the proposing organization is entered in organization box 412. The type of the organization can be selected. Types of organizations include academia, non-profit, government, small business, large business, consulting or catch-all type. In one embodiment, the type of organization is selected using an organizational pull down menu box 414. The date the abstract is posted, the budget for the proposal, the principle investigators name and contact information and project duration can also be entered into posted date box 416, budget box 418, investigators information box 420 and duration box 422, respectively. All of the preceding information along with the proposal abstract number that is assigned on submission of the proposal abstract, are searchable by users of the system.

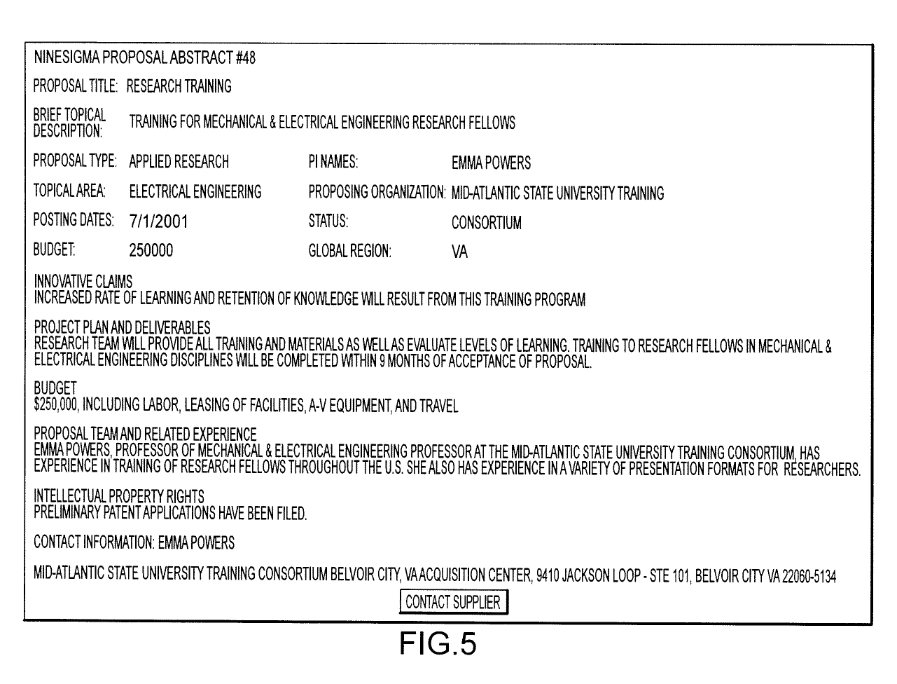

Once the searchable information is entered, details about the proposals are entered. These include brief topical description of the proposal 422, innovative claims or aspect 424 of the proposal, when the plan can be done and what are the deliverables 426, the budget breakdown 428, the proposed team to work on the proposal 430 and their experience and the listing of what steps have been taken to protect the intellectual property rights 432 from the proposal. Only the areas where the author of the proposal has information needs to be completed. Once all known information is related, the supplier gatekeeper would select the submit button 434 to submit the PROPOSAL ABSTRACT to the system. An exemplary proposal is seen in FIG. 5.

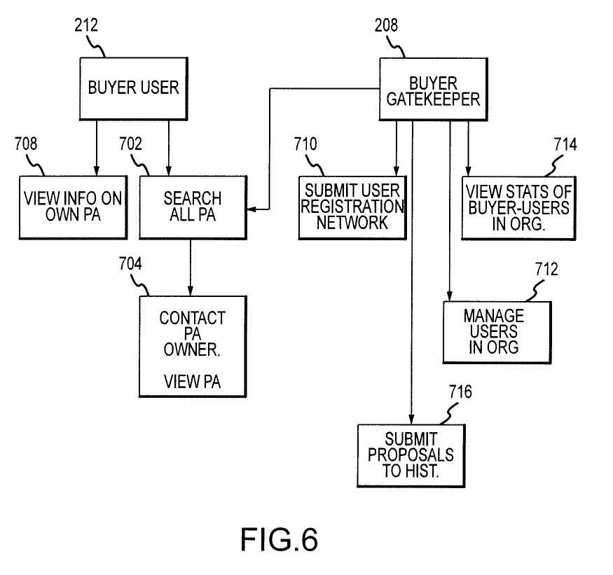

Buyer user web page 212, as illustrated in FIG. 6, lists options that the buyer user can do. In one embodiment these options include searching proposal abstracts 602. Buyer users can contact the proposing organization 604 of Proposal abstracts that were found by the buyer and that the buyer is interested in. Buyer users can also submit registration 606 and other information to buyer gatekeeper. The buyer can also view information regarding any PROPOSAL ABSTRACT submitted by that buyer 608.

Buyer gatekeeper web page 310 lists options available to the buyer gatekeeper. These include management options such as submitting new users 610, organizing users 612 in the organization, and view statistics regarding the buyers in the organization. Additionally, buyer gatekeeper has the option to search for Proposal abstracts 602. The supplier gatekeeper additionally has the ability to submit proposal abstracts 616 in limited circumstances to the host of proposal network. While a buyer typically can not submit proposals, there may be times when a buyer develops technology and wants to find a partner. In that case the proposal first goes to the host so that the host determines that the proposal does not conflict with other proposals.

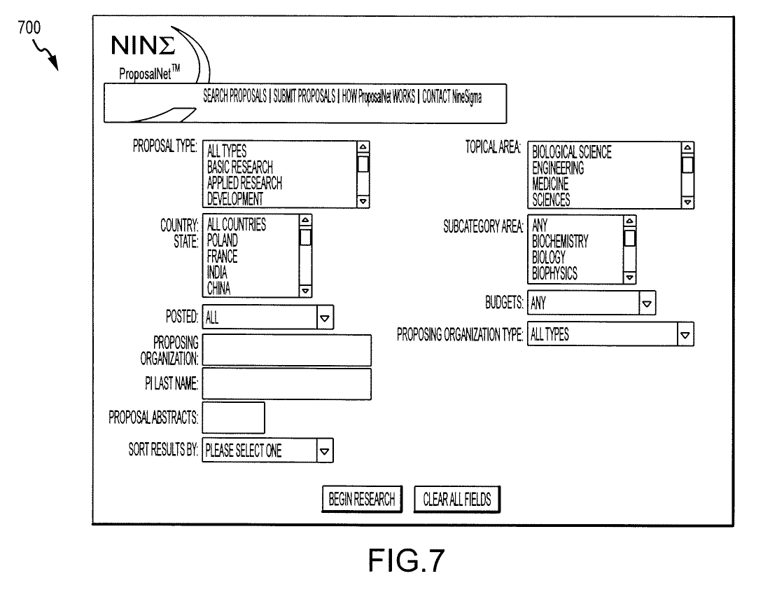

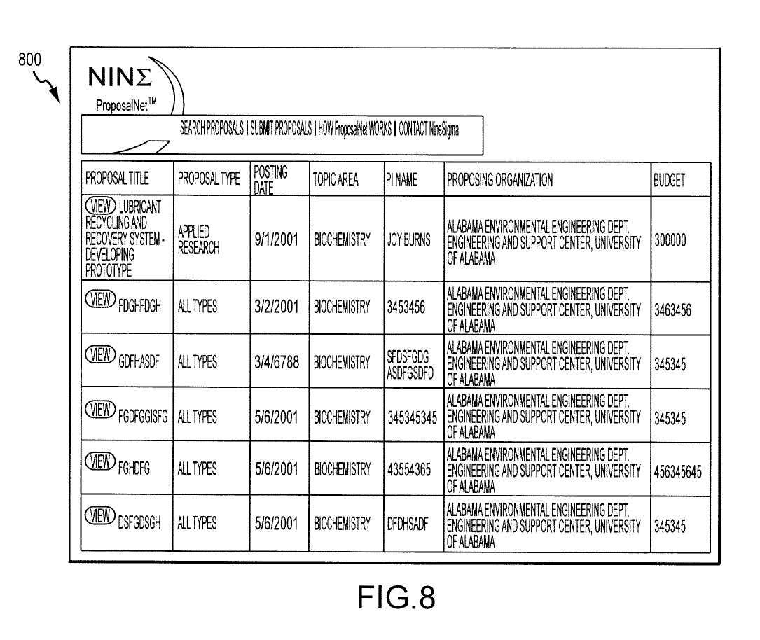

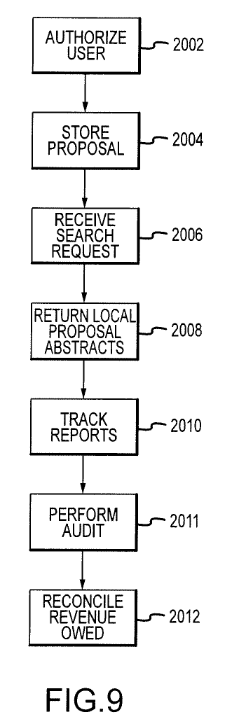

Buyers, both users and gatekeepers, can search any proposal abstract. In one embodiment, searches are initiated on a search page 700 as seen in FIG. 7, the search page includes boxes and pull down menus to enter and select search terms. The searchable information is provided by the suppliers when submitting the Proposal abstracts by filling out the proposal abstract form as illustrated in FIG. 5. As much or as little information can be entered into the search form and the search is initiated by selecting a begin research button 702. The search results 802 are returned in a tabular format as seen in FIG. 8. Individual entries in the table can be selected. This will retrieve the complete proposal abstract, such as the one illustrated in FIG. 5.

As discussed previously in conjunction with FIG. 1, suppliers and buyers are coupled to a server 106. Server 106 is operated by a third party and hosts the proposal network web site. Server 106 provides password protected access to the proposal net web site. The authorization of the user and granting of access to the proposal web site is the first step, step 902, in a method for overseeing the exchange of proposals. User authorization of step 902 includes the determination if the user is a buyer of supplier and if the user is a gatekeeper or a regular user.

In step 904, the server 104 receives Proposal abstract and assigns a tracking number and stores the s in data storage 108. Next, in step 906, search requests are received. The search request received is turned in to a standard search query and the database is searched. Any proposal abstracts found are returned to the requester in step 908. The requester can then view the individual Proposal abstracts.

Additionally, server 106 can track usage and generate reports in step 910. Server 106 can track the vital web statistics such as number of people accessing the home page of the proposal net. In addition, the server can track information regarding member organizations, individual users, proposal abstracts and successful matches. Information tracked regarding member organizations include the number and lists of member organizations, buyer organizations, supplier organizations and the gatekeepers and users for each organization. Information tracked for individual organizations include the total number and lists of individual users, the number and list of individual users per topic area and the usage of the system per topic area. Information regarding PROPOSAL ABSTRACT include the number of PROPOSAL ABSTRACT, the number of PROPOSAL ABSTRACT per criteria, the number of hits on each PROPOSAL ABSTRACT both overall and by organization and a list of all inquiring for each PROPOSAL ABSTRACT. The information regarding successful matches include the total number of successful matches and the number of successful matches per organization. Additional or other information can be tracked in addition to or in place of the information listed above.

The host of server 106 also conducts periodic audits to determine the number of proposals acquired by buyers. These audits are conducted on a regular basis such as every quarter or year.

In one embodiment, the entity hosting the web site and other services generates revenue by receiving commissions on each successful match. The determination of the commission is step 912. In one embodiment the commission is a percent of the deal made between the buyer and the supplier and is paid by the supplier. Also, the commission may be split between the web host and the supplier profit pool that is distributed to suppliers at some interval, such as yearly. In one embodiment, the split is ⅔ to the host and ⅓ to the supplier profit pool. The amount received from the pool can be contingent on how many successful matches a supplier organization made and the popularity of their proposals. This profit sharing provides an incentive for supplier organizations to participate in the program.

Having now described preferred embodiments of the invention; modifications and variations to the present invention may be made by those skilled in the art. The invention is thus not limited to the preferred embodiments, but is instead set forth in the following clauses and legal equivalents thereof.

What is claimed:

1. A method for facilitating the development of research proposals comprising: registering each user as a supplier or as a buyer; for each of the suppliers, accepting one or more proposal abstracts; storing each proposal abstract in a database; receiving a search request for proposal abstracts meeting a criteria from at least one of the buyers; sending a list of matching proposal abstracts that meet the criteria of the search request to the one of the buyer; receiving a request to view one or more of the proposal abstracts from the list of matching proposal abstracts from the one of the buyer; and send each of the one or more proposal abstracts to the buyer.

2. The method of claim 1 further comprising identifying at least one supplier from a group of suppliers as a supplier gatekeeper and the remainder of the group supplier users.

3. The method of claim 2 wherein the gatekeeper supplier submits the proposal abstracts.

4. The method of claim 1 further comprising identifying at least one buyer from a group of buyers as a buyer gatekeeper and the remainder of the group buyer users.

5. The method of claim 2 wherein the gatekeeper buyer submits the proposal abstracts.

6. The method of claim 1 wherein the buyer accepts one of the proposals by paying a bid price.

7. The method of claim 6 further comprising auditing the buyers and suppliers to determine the number of proposals accepted by the buyer.

8. The method of claim 7 further comprising remitting a portion of the bid price to a host of the proposal network.

9. A system for presenting proposals for acceptance comprising: a server computer having a processor and memory, the server operable to: register each user as a supplier or as a buyer; for each of the suppliers, accepting one or more proposal abstracts; storing each proposal abstract in a database; receiving a search request for proposal abstracts meeting a criteria from at least one of the buyers; sending a list of matching proposal abstracts that meet the criteria of the search request to the one of the buyer; receiving a request to view one or more of the proposal abstracts from the list of matching proposal abstracts from the one of the buyer; and send each of the one or more proposal abstracts to the buyer.

10. The system of claim 9 further comprising identifying at least one supplier from a group of suppliers as a supplier gatekeeper and the remainder of the group supplier users.

11. The system of claim 10 wherein the gatekeeper supplier submits the proposal abstracts.

12. The system of claim 9 further comprising identifying at least one buyer from a group of buyers as a buyer gatekeeper and the remainder of the group buyer users.

13. The system of claim 10 wherein the gatekeeper buyer submits the proposal abstracts.

14. The system of claim 9 wherein the buyer accepts one of the proposals by paying a bid price.

15. The system of claim 14 wherein a host audits the buyers and suppliers to determine the number of proposals accepted by the buyer.

16. The system of claim 15 wherein the host is remitted a portion of the bid price to a host of the proposal network.
